(19) United States
(12) Patent Application Publication
(10) Pub. No.: US 2016/0078548 A1
(43) Pub. Date: Mar. 17, 2016

(54) Pension Transaction Platform

(71) Applicant: Mercer (US) Inc., New York, NY (US)

(72) Inventors: Richard McEvoy, New York, NY (US); Aikaz Makarovskiy, Allendale, NJ (US); Rachel Wheeler, Brooklyn, NY (US); Leah Evans, London (GB)

(21) Appl. No.: 14/690,002

(22) Filed: Apr. 17, 2015

Related U.S. Application Data
(60) Provisional application No. 62/049,157, filed on Sep. 11, 2014.

(51) Int. Cl. G06Q 40/08; G06Q 10/10

(52) U.S. Cl. CPC G06Q 40/08; G06Q 10/1057

(57) ABSTRACT

A buyout management system includes a buyout processor to prepare a sponsor to conduct a buyout transaction and enable the sponsor to execute the buyout transaction upon the determination that the time is appropriate to do so. The buyout processor generates a readiness metric by applying a readiness ruleset to sponsor attributes. Using the readiness metric, an obtained quote from an insurer and attributes associated with the insurer, the buyout processor can generate a transaction readiness level that is compared to trigger thresholds. Upon the transaction readiness level meeting the trigger threshold, the buyout processor executes the buyout transaction.

This application claims priority to U.S. provisional application 62/049,157, filed Sep. 11, 2014. U.S. provisional application 62/049,157 and all other extrinsic references contained herein are incorporated by reference in their entirety.

### FIELD OF THE INVENTION

The field of the invention is pension management technologies.

### BACKGROUND

The background description includes information that may be useful in understanding the present invention. It is not an admission that any of the information provided herein is prior art or relevant to the presently claimed invention, or that any publication specifically or implicitly referenced is prior art.

Pension management presents an on-going challenge for organizations such as employers. As organizations grow and change, they might not be willing or able to handle the responsibilities associated with managing their employees' pension plans. As such, an attractive option can be to perform a pension buyout with an insurer, whereby the insurer can assume the management of the employees' pension plan from the organization.

Unfortunately, existing pension buyout transactions for an organization typically involve a slow process of going back-and-forth with prospective insurers with regard to obtaining quotes, vetting insurer candidates, and ultimately executing the buyout transaction itself. Additionally, organizations typically only explore performing buyouts after they've identified the need to do so. Thus, the organizations (and their employees) are left at the mercy of a reactive mechanism that leaves the organizations at a timing and negotiating disadvantage. Additionally, the burden associated with the organization's continued managing of the pension plans is prolonged while the actual negotiations are ongoing until the buyout transaction is ultimately executed.

Others have put forth efforts towards systems and methods directed to benefits management. For example, U.S. Pat. No. 7,933,785 to Mau is directed to a real-time benefits marketplace that can determine price compatibility. U.S. Pat. No. 8,249,900 to Long, et al, is directed toward creating a mutual insurance company for the purposes of terminating a pension plan. U.S. issued U.S. Pat. No. 8,762,182 to Hueler is directed to facilitating annuity transactions between annuity purchasing individuals and providers.

However, the existing efforts are all reactive in nature and fail to assist organizations in determining a potential best time to act, based on the individual organization's evolving state and needs.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is still a need for systems and methods that can assist an organization in preparing for a potential buyout transaction and determining an optimal time to proceed with the buyout.

### SUMMARY OF THE INVENTION

The inventive subject matter provides apparatus, systems and methods in which an organization's readiness for a pension buyout can be assessed and, when the time is right for the organization, executed with a potential insurer.

The system can include a buyout processor that is programmed to obtain sponsor attributes related to a sponsor in preparation for a potential buyout transaction. The sponsor attributes can be stored on a sponsor database. The buyout processor can, based on the sponsor attributes, instantiate a readiness metric using a readiness ruleset applied to the sponsor attributes that is indicative of the sponsor's general level of readiness to execute a buyout transaction.

Having instantiated the readiness metric, the buyout processor can provide one or more potential insurers with sponsor attributes necessary for the insurers to generate a quote for the buyout transaction. The system can include an insurer database, which can receive the generated quote from insurers as well as store insurer attributes associated with the insurers. The system can require that an insurer's quote be refreshed periodically (daily, weekly, monthly, etc.) based on updated sponsor attributes and other relevant data (market data, etc.).

The buyout processor can receive the insurer quote (from the insurer directly or from the insurer database), obtain insurer attributes and use the readiness metric, the insurer quote, and the insurer attributes to derive a transaction readiness level. The transaction readiness level can be considered to be representative of the sponsor's readiness to proceed with the buyout transaction with that particular insurer at the particular quote provided by the insurer.

Upon the transaction readiness level meeting a trigger threshold, the buyout processor can proceed with executing the buyout transaction with the insurer according to the insurer's quote. In embodiments, executing the transaction can include generating a recommendation and providing the recommendation to the sponsor for approval. Upon receiving the approval from the sponsor, the buyout processor can proceed with executing the buyout transaction.

The system can include sponsor interface(s) and insurer interface(s) for the sponsors and insurers to interact with various features and functions of the system, respectively.

In embodiments, the system can include one or more checklists whose entries must be satisfied prior to proceeding further within the transaction preparation and/or execution process.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is an illustrative overview of a pension management system.

FIG. 2 is provides an illustrative example of sponsor database having sponsor information associated with a sponsor.

FIG. 3 provides a flowchart illustrating example processes of the inventive subject matter.

FIG. 4 provides a detailed flowchart of the generation of the readiness metric.

FIG. 5 is a modified flowchart of FIG. 3, to include the logical incorporation of various checklists.

FIG. 6A is an illustrative example of a plan checklist.

FIG. 6B is an illustrative example of a due diligence checklist.

FIG. 6C is an illustrative example of a stakeholder checklist.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

As used herein, a “sponsor” can be considered to be an entity holding a benefit plan, such as a pension plan, for a plurality of individuals (“members”). A sponsor can be an employer or other organization that manages the benefit plan for its members. As used herein the “insurer” can be considered to be an entity to which a sponsor can transfer the responsibilities associated with the benefit plan via a buyout transaction.

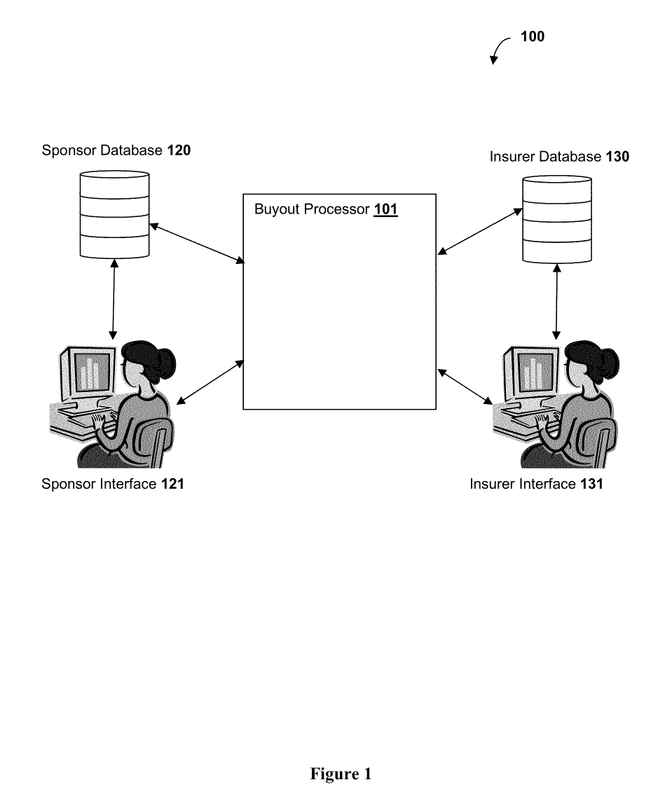

FIG. 1 provides an example of a pension management system 100 associated with the inventive subject matter. As shown in FIG. 1, the components of system 100 can include a buyout processor 101, at least one sponsor database 120 communicatively coupled with the buyout processor 101, and at least one insurer database 130 communicatively coupled with the buyout processor 101. The system 100 can also include one or more sponsor interface(s) 121 associated with one or more sponsors (communicatively coupled with the buyout processor 101 and/or the sponsor database 120), and one or more insurer interface(s) 131, associated with one or more insurers (communicatively coupled with the buyout processor 101 and/or the sponsor database 120).

While FIG. 1 illustrates a single sponsor database 120, a single sponsor interface 121, a single insurer database 130, and a single insurer interface 131, it is contemplated that the system 100 can include more than one of each of these components connecting with each other and with the buyout processor 100. As such, each sponsor interface 121 can be connected to one or more than one sponsor database(s) 120 and conversely, each sponsor database 120 can be connected to one or more than one sponsor interface(s) 121. Similarly, each insurer interface 131 can be connected to one or more than one insurer database(s) 130 and each insurer database 130 can be connected to one or more than one insurer interface(s) 131.

As described in further detail below, the buyout processor 101 executes various functions and processes associated with the inventive subject matter. In embodiments, the buyout processor 101 can comprise one or more computer processors that are programmed to perform functions and processes associated with inventive subject matter. In embodiments, the processor-executable instructions of buyout processor 101 can be stored on one or more non-transitory computer-readable storage media, and can be executed by the one or more processors of buyout processor 101 to execute the functions and processes of the inventive subject matter. In embodiments, the processor-executable instructions associated with buyout processor 101 can be hard-coded into the one or more processors themselves.

The sponsor interface 121 and insurer interface 131 can each be one or more computing devices programmed to receive user input and present information to the users, such that users can interact with various processes and functions associated with system 100. In embodiments, sponsor interface 121 and/or insurer interface 131 can be web services or API interfaces presented via computing devices, provided by system 100, for users to interact with the various components, functions and processes of the system 100.

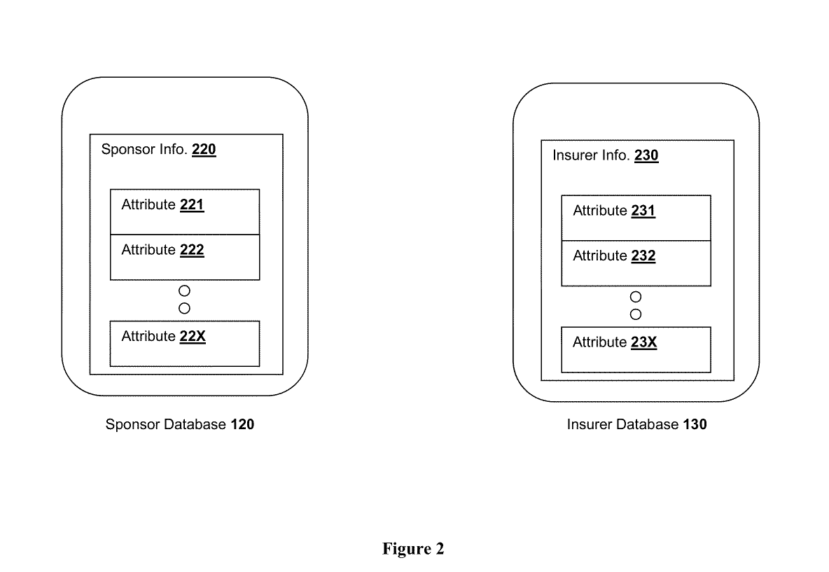

FIG. 2 provides an illustrative example of sponsor database 120 having sponsor information 220 associated with a sponsor, the sponsor information 220 including attributes 221-22x.

The sponsor database 120 stores information associated with a sponsor. This can include information associated with the sponsor itself, benefit plans held by the sponsor, and the members associated with the sponsor's benefit plans. The sponsor information 220 can be in the form of sponsor attributes 221-22x associated that are associated with the corresponding sponsor. The sponsor database 120 can be embodied as non-transitory computer-readable storage media configured to store this data associated with the sponsor. In embodiments, the sponsor database 120 can store sponsor information associated with more than one sponsor. In other embodiments, a sponsor database 120 can be associated with a single sponsor and store only the data associated with that sponsor.

Examples of sponsor attributes 221-22x can include information associated with a sponsor and one or more aspects of one or more benefit plans held by the sponsor, such as sponsor strategy attributes (e.g., associated with goals of the sponsor or state of the sponsor beyond the plan), plan identifiers, cost of liabilities, settlement charge, a general funding status (pre-buyout and/or post-buyout), a funding status on accounting basis (pre-buyout and/or post-buyout), a funding status on IRS funding basis (pre-buyout and/or post-buyout), current accounting expenses (pre-buyout and/or post-buyout), future accounting expenses, plan participant information (e.g., number of participants, demographics information, etc.), implied yield, equivalent yield, accounting liability, funding liability, economic liability, future cash contributions, settlement accounting, and other key performance indicators (e.g. additional impacts of executing a buyout on sponsor cash reserves, income statements, sponsor balance sheets, etc), insurer impression (e.g., for certain insurers, an attribute representative of the sponsor's opinion or perception of the insurer's quality, reputation, etc.—in embodiments, these attributes can be used as a weighting factor or other modifier applied to an analysis involving specific insurers; in embodiments, the insurer impressions can be considered to reflect the results of a sponsor's due diligence regarding potential insurers). In embodiments, the sponsor attributes 221-22x can be modified according to current market conditions, as appropriate.

The sponsor attributes 221-22x used in the analysis can be selected in various ways, depending on the type of attribute. Attributes associated with the benefit plans can be automatically included, imported into the sponsor database 120 from databases or other computing systems associated with and/or operated by the benefit plan providers, or from information held by the sponsor internally. Attributes associated with the sponsor (e.g., strategy attributes, funding-, accounting- and other sponsor-related attributes) can be selected and or modified by authorized personnel associated with the sponsor. The sponsor can add or remove certain attributes from the analysis, and adjust their relative importance in influencing a decision to proceed with a buyout. For example, if a sponsor deems that the cost of liabilities is a particularly important factor given their particular situation, they can select to include this attribute and increase the relative weight of the attribute (such as via adjustments to a readiness ruleset, as discussed in further detail below). Conversely, if the sponsor does not have any particular impression about any of the insurers, or if they deem their particular opinion as having relatively low influence on their decision to pursue the buyout, they can opt to remove the attribute reflective of their opinion from consideration or decrease the relative weight of the attribute for use in the analysis.

In embodiments, the sponsor attributes 221-22x can include an acceptable quote attribute. The acceptable quote attribute is representative of a quote value from an insurer that the sponsor would accept if the sponsor was completely ready to proceed with the buyout transaction without regard to the individual insurer's qualities. Thus, in embodiments, the acceptable quote attribute can be a current market value of a buyout for a particular plan. In other embodiments, the acceptable quote attribute can be derived from historical quotes associated with a particular plan. In other embodiments, the acceptable quote attribute can be provided by the sponsor via sponsor interface 121.

The insurer database 130 stores information associated with an insurer. This can include information about the insurer itself, quotes associated with one or more benefit plans, historical quotes, reputation, etc., in the form of insurer attributes.

FIG. 2 provides an illustrative example of insurer database 130 having insurer information 230 associated with an insurer, the insurer information 230 including attributes 231-23x.

Examples of insurer attributes include insurer funding level, insurer reputation, insurer legal requirement compliance values (e.g., measured metrics of an insurer relative to legal requirements or qualifications), insurer financial strength-indicating metrics, credit rating (from rating agencies), asset quality, business line diversification, administrative capabilities, past annuity buyout experience, products available, previous litigation, etc. In embodiments, the insurer attributes 231-23x can be modified according to current market conditions, as appropriate.

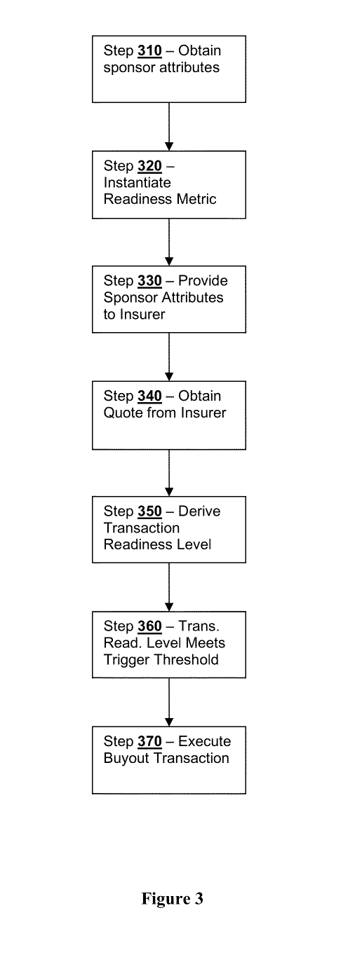

FIG. 3 provides a process flowchart illustrating functions and processes of the inventive subject matter.

The buyout processor 101 uses information associated with a sponsor from the sponsor database 120 to determine a readiness of a sponsor. To do so, at step 310, the buyout processor 101 obtains sponsor attributes 221-22X associated with a sponsor from sponsor database 120 and instantiates a readiness metric based on sponsor attributes associated with the sponsor according to a readiness ruleset at step 320.

The readiness metric can be an instantiated data object having sponsor attributes whose interrelationship as well as individual values can be used to represent the readiness or urgency of the sponsor to execute the transaction. Changes in the readiness metric can be considered to reflect the impact of a buyout on the sponsor attributes 221-22x.

The readiness metric is instantiated by applying the readiness ruleset to the sponsor attributes 221-22x. The readiness ruleset is a set of rules that sets forth the interrelationship between various sponsor attributes, their relative influence in the determination of readiness, trigger conditions for the execution of a buyout transaction, and trigger values for sponsor attributes that can be considered to be trigger attributes.

Attributes can be weighted in their contribution to an overall readiness value, such as via pre-set weighting schemes applied to individual attributes or groups of attributes being used in the analysis. The readiness ruleset can be a default ruleset that can be modified by the sponsor to account for the individual sponsor's particular priorities. For example, the relative weights of various attributes and/or trigger thresholds can be adjusted by the sponsor.

In embodiments, the readiness ruleset can be a set of rules that apply an equal weight to all of the sponsor attributes 221-22x used in the analysis. In embodiments, the readiness ruleset can include unequal weighting to the sponsor attributes 221-22x used in the analysis. For example, sponsor attributes that are more sensitive or subject to daily changes can be a priori given greater weight than others that remain relatively static. In an illustrative example, sponsor attributes that are updated daily can be given a greater weight than those updated weekly, which in turn are given greater weight than sponsor attributes updated monthly. In another illustrative example, sponsor attributes having a larger statistical daily variance (such as by a historical analysis of variance of the particular attribute) can be weighted more heavily than those that are more resistant to variance (so that the readiness level is therefore more sensitive to these changes) or weighted less heavily than those that are more resistant to variance (so that the effect of a larger margin of error in daily fluctuations does not unduly affect the readiness level).

The readiness level represented by the readiness metric can be expressed as a readiness score (e.g., a single score value as a function of the various sponsor attributes, or as a combination of score values based on various sponsor attributes) or as a percentage relative to baseline values or along a range or spectrum of readiness scores. Thus, a readiness metric indicating a low readiness (e.g., via a low readiness score or low percentage of readiness) reflects a sponsor who is not yet ready to carry out the buyout (e.g., because the conditions are not yet optimal for the sponsor, there is no urgency/need to do so yet, etc.). In embodiments, the sponsor attributes 221-22x can include target attribute values for each attribute, which is the ideal value or “readiness” for the particular sponsor attribute as a part of the larger set of conditions represented by the set of sponsor attributes 221-22x used in the analysis.

In embodiments, the target attribute values can be entered by the sponsor (e.g., authorized sponsor personnel via sponsor interface 101) reflecting the target values the sponsor deems to be representative of optimal conditions to execute the buyout. In embodiments, the target attribute values can be obtained from a reference database where the attribute values can be grouped by scenario (such as a buyout scenario indexed by a collective set of attributes associated with each target value) and/or individually indexed according to the attributes associated with the target value.

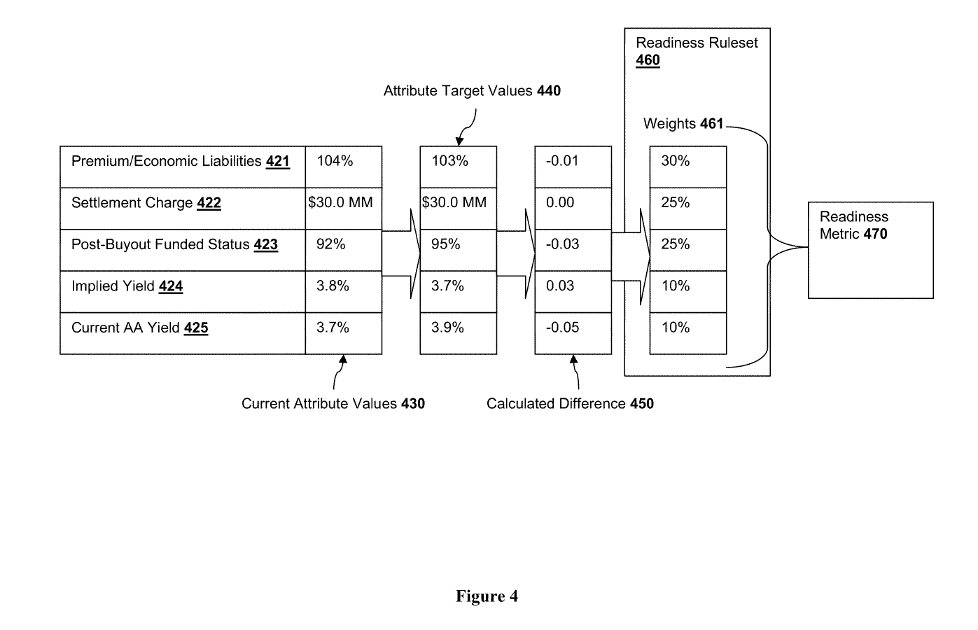

In embodiments, the buyout processor 101 is programmed to instantiate the readiness level by determining a difference between the attribute value of each sponsor attribute 221-22x to the target level (as a percentage difference) and aggregating the determined differences into the readiness level according to the weighting scheme of the readiness metric. FIG. 4 provides an illustrative example of the generation of a readiness metric of step 320 by applying a readiness ruleset 460 to a set of sponsor attributes 421-425 having associated current attribute values (collectively referenced as current attribute values 430). In the illustrative example, the buyout processor 101 obtains target values (collectively referenced as attribute target values 440) for each of the sponsor attributes 421-424 and determines a calculated difference (collectively, 450) between each of the attribute values 430 and their respective target values 440. It should be noted that for some attributes, a greater value is considered “better” from the perspective of the sponsor (i.e., a greater value will contribute more positively to the readiness level) and as such a current value 430 not meeting a target 440 will be lower (for example, for the post-buyout funded status attribute 423) whereas for other attributes, a lesser value is considered “better” (i.e., a lower value contributes more positively to the readiness level) from the perspective of the sponsor (for example, the premium/economic liabilities attribute 421).

In embodiments, the difference values 450 can be expressed as a percentage of difference between the attribute values 430 and respective target values 440 (or a decimal corresponding to the difference as illustrated in FIG. 4). In these embodiments, the difference represents the difference to which a current attribute value 430 fails to meet the target, and can be expressed as a positive or negative percentage. In embodiments, the buyout processor 101 can be programmed to only consider deficiencies between a current attribute value 430 and a target value 440. Thus, in these embodiments, the buyout processor 101 considers any attribute value that meets or exceeds its corresponding target value to have a difference of 0%. In alternative embodiments, the buyout processor 101 can consider the magnitude to which a current value exceeds a target, which can be used to counter the negative effect of other attributes not meeting their target values. In these examples, the percentage that a particular attribute value exceeds a target will have an opposite sign from the percentage used to denote a failure to meet a target. Thus, if a failure to meet a target is expressed as a positive percentage, exceeding a target is expressed as a negative percentage and vice-versa.

In FIG. 4, the premium economic liabilities attribute 421, the post-buyout funded status attribute 423 and the current AA yield attribute 425 are shown having negative values because their respective current values 430 do not meet their corresponding target values 440. Because the implied yield attribute 424 has a current value exceeding the target, it is expressed as a positive number. As the current value of the settlement charge attribute 422 is exactly at its target value, its difference is zero.

In embodiments, the difference values 450 can be expressed in a percentage or (decimal amount corresponding to the percentage) of the current attribute value 430 for a particular attribute relative to its corresponding target value 440. Thus, values that do not exceed the target can be expressed as a value within the range from 0 to a decimal value less than 1, those that meet the target have a value of 1 and those that exceed the target have a decimal value of greater than 1.

Having calculated the differences 450 for each of the attributes 421-425, the buyout processor 101 applies readiness ruleset 460 to determine the readiness metric. Readiness ruleset 460 is illustrated having attribute weights 461 applied to each of the attributes 421-425. As illustrated herein, the weighting here is used to increase the effect of the first three attributes 421-423 in the calculation of the readiness score relative to the remaining two attributes 424-425. In the example of FIG. 4, the buyout processor 101 instantiates the readiness level 470 as a weighted average of the calculated difference values 450 as affected by the weights 461 of the readiness ruleset 460. Thus, the readiness metric 470 includes this calculated weighted average value. The readiness metric 470 can be a multi-dimensional object, and as such can include the weighted difference values of each of the attributes 421-425, determined by the buyout processor 101 based on the calculated difference values 450 and the corresponding weights 461.

At step 330, the buyout processor 101 provides certain sponsor attributes to one or more insurers, the sponsor attributes being the necessary information for the insurer to generate a quote. The sponsor attributes provided can be a priori defined according to the plan subject to the buyout, sponsor preferences, and/or insurer preferences (such as a designation of attributes needed by the insurer to generate the quote). Based on the provided sponsor attributes, the insurer can generate the quote for the buyout. The quote can be stored on the insurer database 130. In embodiments, the buyout processor 101 can give the insurer a time limit to provide the quote before the sponsor attributes are no longer considered current, for example a day, a week, a month, etc. In embodiments, the quote can have an expiration date or expiration time, upon which the quote is no longer considered current. In embodiments, the expiration date of a quote can be the same as the time limit given to an insurer to provide a quote, thus promoting a periodically refreshed quote in response to periodically refreshed sponsor attributes. In these embodiments, the buyout processor 101 can delete the quote from database 130, reducing the risk that an expired quote can be provided to a sponsor and conserving storage space on database 130. At step 340, the buyout processor 101 receives the quote from the insurer. The buyout processor 101 can receive the quote directly from the insurer, or obtain it from insurer database 130.

The buyout processor 101 can then derive a transaction readiness level as a function of the readiness metric, the quote provided by the insurer, and the insurer attributes associated with the insurer at step 350. The transaction readiness level represents the degree to which the sponsor is ready to execute the transaction with the particular insurer that provided the quote. Thus, for one sponsor looking to execute a buyout on one plan, having one calculated readiness metric, there can be a plurality of transaction readiness levels associated with a plurality of insurer quotes associated with different insurers. The transaction readiness level can be expressed as a percentage or score associated with this readiness to execute the transaction with the particular insurer.

In embodiments, to derive the transaction readiness level, the buyout processor 101 can correlate one or more of the sponsor attributes to one or more of the insurer attributes via mapping, statistical correlation, or other association, to determine whether the insurer attributes sufficiently match the sponsor attributes. The sponsor attributes can include attributes used in the readiness metric calculation (such as those related to funding to ensure the insurer will have sufficient funding for the plan management) or other sponsor attributes. For example, a sponsor attribute of a desired insurer reputation can be mapped to an insurer's reputation attribute; sponsor-desired asset quality levels for insurers can be mapped to the insurer's asset quality attribute, and so forth.

The buyout processor 101 determines a correlation score based on the similarity of the sponsor attributes and the corresponding insurer attributes via statistical correlations, clustering, calculation of percentage differences, or other techniques, and aggregates these calculated similarities into a collective correlation score. The various correlations can be weighted in calculating the correlation score based on a designated priority of the attributes by the sponsor (for example, if reputation is ranked highly, the correlation score between the desired reputation and the insurer's reputation attribute can be weighted more heavily, etc.). As the correlation score reflects the amount or degree of similarity between the insurer's attributes and the corresponding sponsor attributes, it can be expressed as a percentage or decimal expressing this difference.

The buyout processor 101 then determines a quote similarity score by comparing the acceptable quote attribute to the obtained insurer quote. The quote similarity score is the calculated similarity (alternatively, can be calculated as the difference) between the acceptable quote attribute and the obtained insurer quote, and can be expressed as a percentage or decimal value reflecting the calculated similarity (or difference) between the acceptable quote attribute and obtained insurer quote. In embodiments, if insurer quote is more favorable (a lower amount) than the acceptable quote attribute value (i.e., the insurer's quote is actually better than what the sponsor indicated would be acceptable), the quote similarity score can be expressed as being over 100% similar (or in decimal form, having a value over 1.0). If the quote similarity score is calculated as a difference, in these situations the calculated difference can be expressed having the opposite mathematical sign of situations where the insurer's quote does not exceed (i.e., is not more favorable to the sponsor) than the sponsor's acceptable quote attribute. Thus, for example, an insurer quote having a “worse” difference (i.e. higher) than the acceptable quote substitute can be expressed as a positive percentage (or a negative percentage) and a “better” difference can be a expressed as a negative percentage (or as a positive percentage, respectively).

The buyout processor 101 then aggregates the readiness metric, the correlation score, and the quote similarity score to derive the transaction readiness level. To facilitate the aggregation, the readiness metric, the correlation score and quote similarity score are all preferably of the same derived calculation type (i.e., a calculated similarity or difference for their respective calculations). However, it is contemplated that the buyout processor 101 can adjust the values to bring them into a common namespace (e.g., from a calculated similarity for the correlation score, derive a calculated difference if the readiness metric and the quote similarity score are both generated from a calculated difference in their respective processes). In embodiments, each of the readiness metric, the correlation score and quote similarity score can be weighted equally such that the transaction readiness level is an average score of these three metrics expressed as a percentage or decimal. In other embodiments, one or more of the readiness metric, the correlation score, and the quote similarity score can be weighted differently according to sponsor preferences. In these embodiments, the sponsor can modify the weights via sponsor interface 121.

At step 360, the buyout processor 101 determines that the transaction readiness level meets a trigger threshold. The trigger threshold is a value in the same namespace of the transaction readiness level that must be met or exceeded for the transaction to be executed by the buyout processor 101. Thus, if the transaction readiness level is a percentage, the trigger threshold is a percentage that the transaction readiness level must meet to trigger the execution of the transaction by the buyout processor 101.

In embodiments, the trigger threshold can be a percentage of 100% similarity (for transaction readiness levels derived via similarity calculations; for decimal values a value of 1) or 0% difference (for transaction readiness levels derived via difference calculations; for decimal values, a value of 0). In other embodiments, the trigger threshold can be less than 100% (or greater than 0%) as it may be extremely unlikely or maybe even impossible to reach a transaction readiness level of 100% (or 0%).

In embodiments, the trigger threshold can be a set threshold determined by the sponsor, via sponsor interface 121. In embodiments, the trigger threshold can be based on a historical analysis of past buyout transactions executed by the system. The historical analysis can be industry-wide, based on a benefit plan or set of benefit plans (corresponding to the sponsor plan or similar to the sponsor plan for which the process is being executed by the system) or to a particular insurer or set of insurers. To determine the trigger threshold based on the historical analysis, the buyout processor 101 can aggregate the transaction readiness levels that triggered or resulted in execution of the historical buyout transactions and via statistical techniques (averaging, clustering, etc.), set the trigger threshold.

In embodiments, the transaction readiness level can be reapplied to one or more of the sponsor attributes, one or more of the insurer attributes, and/or the quote to determine values for the sponsor attributes, insurer attributes, or quote that would satisfy the trigger threshold. These “satisfaction” values for various attributes can be presented, as appropriate, to the sponsor and/or the insurer via sponsor interface 121 and insurer interface 131, respectively.

In response to the transaction readiness level meeting the trigger threshold, the buyout processor 101 proceeds with processing a buyout transaction between the sponsor and the insurer at step 370.

In embodiments, certain sponsor attributes and/or insurer attributes can be considered to be trigger attributes having trigger attribute thresholds, such that upon meeting the thresholds (either alone, or in combination with other trigger attributes) can trigger the processing of the buyout transaction even if the transaction readiness level does not meet its own trigger threshold.

In embodiments, the trigger attribute thresholds can be set and/or adjusted by the sponsor, such that the trigger attribute thresholds are decreased or increased (i.e., they are made more likely, thus “easier” to meet or less likely, thus “more difficult” to meet, respectively). In embodiments, for certain attributes, the thresholds can be dependent on and/adjusted based on current (and/or periodically updated) market conditions. Thus, the trigger attribute thresholds can be adjusted to account for market conditions that are more favorable or less favorable to the sponsor. In these embodiments, the sensitivity of the threshold to market conditions can be additionally set or adjusted by the sponsor, such that the threshold is more susceptible to or more resistant to (and possibly immune to) changes in market conditions.

In embodiments, the readiness ruleset can include an identification of trigger attributes and their corresponding trigger attribute thresholds. If the trigger attributes are linked such that more than one trigger attribute must meet their respective trigger attribute thresholds for the buyout processor 101 to be triggered into proceeding with the execution of the transaction, the readiness ruleset can include the identification of each of the trigger attributes and their corresponding trigger thresholds. It is contemplated that the readiness ruleset can include rules that require all designated trigger attributes to meet their trigger attribute thresholds to cause the buyout processor 101 to proceed to execution of the buyout transaction, or that the rules can dictate that less than all of the trigger attributes must meet their trigger attribute thresholds. For example, if three of the sponsor attributes used in an analysis are designated trigger attributes, the rules can dictate that two of the three must meet their trigger attribute thresholds to trigger the buyout processor 101 to proceed with the execution. In another example, one of the three trigger attribute can be designated as “required” such that two of the three are required but that the required trigger attribute must be one of the two meeting the threshold (in other words, if the two non-required trigger attributes meet their respective trigger thresholds without the required trigger attribute meeting its respective trigger threshold, the readiness ruleset will not trigger the buyout processor 101 to proceed with the transaction).

In these embodiments, any sponsor-adjustable trigger attributes (i.e. selection of an attribute to designate as a trigger attribute or removal of a designation of an attribute as a trigger attribute) and/or their sponsor-adjustable trigger attribute threshold can be modified by the sponsor via sponsor interface 121, resulting in a modification to the readiness ruleset being applied to the sponsor attributes. The modified readiness ruleset can be saved for future implementation or use as a customized readiness ruleset.

Returning to the example illustrated in FIG. 4 as an illustrative example of these embodiments, it is supposed that a sponsor designates the premium/economic liabilities attribute 421, the settlement charge attribute 422 and the post-buyout funded status attribute 423 as trigger attributes. Accordingly, the readiness ruleset 460 designates their respective attribute target values 440 as the trigger threshold attributes for the trigger attributes and includes executable instructions indicating that if all three of the trigger attributes 421, 422, 423 meet their trigger attribute threshold values 440, the buyout processor 101 proceed with executing the buyout transaction. In this example, the settlement charge attribute 422 meets its trigger attribute threshold 440 but the other two trigger attributes do not, so the buyout processor 101 would not yet be triggered to proceed automatically with the transaction.

In this example, the attribute target values 440 are illustrated as being designated as the trigger attribute thresholds for the sponsor attributes that are designated as trigger attributes. However, it is contemplated that in embodiments the trigger attribute thresholds for trigger attributes can be set to be more “difficult” to achieve than the attribute target values 440 (for attribute target values used in attributes where a higher value is considered beneficial to sponsor in a buyout process, the trigger attribute threshold values will be higher than the attribute target values 440; for attribute target values used in attributes where a lower value is considered beneficial to sponsor in a buyout process, the trigger attribute threshold values will be lower than the attribute target values 440). As such, triggering the execution of the buyout transaction via the trigger attributes requires that the values of the trigger attributes actually surpass each of the attribute target values 440 by an amount (the amount required to meet the trigger attribute threshold values) rather than merely meeting the attribute target values 440. In these embodiments, setting the trigger attribute thresholds “beyond” the attribute target values 440 allows for the “shortcutting” via the triggering of the buyout processor 101 to execute the transaction in especially favorable circumstances while maintaining the “normal” process if the attribute target values 440 are met.

It should be noted that the use of the trigger attributes can be performed at the stage of generation of the readiness metric (step 320) and/or at the derivation of the transaction readiness level (step 350). Thus, if the trigger attribute thresholds are met at step 320 according to the rules of the particular readiness ruleset, the buyout processor 101 can proceed directly to step 330 without waiting for all of the remaining sponsor attributes to meet their target values. Similarly, if the trigger attribute thresholds are met at stage 350 the buyout processor 101 then proceeds to execute the buyout transaction even if the transaction readiness level does not yet meet the trigger threshold.

In embodiments, the sponsor can monitor the status of designated trigger attributes via sponsor interface 121. In these embodiments, the buyout processor 101 can be programmed to present the list of sponsor attributes being used to determine the readiness metric and/or the transaction readiness level (along with the other components used in the derivation of the transaction readiness level), including those sponsor attributes designated as trigger attributes. For all of the sponsor attributes and/or just the trigger attributes, the buyout processor 101 can present the status of each attribute with respect to its target values and/or trigger attribute threshold values. This can be done via a graphical presentation (highlighting those attributes meeting their target and/or trigger values in green, those not meeting their targets/triggers in red, for example) presented on sponsor interface 121.

The following illustrates an alternative derivation of the transaction readiness level and trigger threshold according to other embodiments of the inventive subject matter. In these embodiments, the buyout processor 101 can generates an adjusted quote by applying the correlation score to the quote provided by the insurer as an adjustment factor. Thus, the adjusted quote will differ from the insurer's provided quote proportionally with the correlation score. In these embodiments, the adjusted quote is used as the trigger threshold.

The buyout processor 101 then applies the aggregated readiness metric value to the acceptable quote attribute to generate an acceptable readiness quote attribute. For example, the aggregated readiness metric value (a percentage or decimal) can be used as an adjustment factor to modify the acceptable quote attribute to generate the acceptable readiness quote attribute's value. In these embodiments, the acceptable readiness quote attribute is used as the transaction readiness level.

Subsequently, the buyout processor 101 monitors the transaction readiness level (which is the acceptable readiness quote attribute) and the trigger threshold (the adjusted quote), and when the buyout processor 101 determines that the transaction readiness level meets the trigger threshold (step 360), the buyout processor 101 proceeds to execute the buyout transaction (step 370).

In embodiments, the processing of the buyout transaction by the buyout processor 101 at step 370 can encompass executing the buyout transaction between the sponsor and the insurer. In these embodiments, a sponsor will have provided authorization for the buyout processor 101 to automatically proceed with the execution of the transaction according to the conditions that caused the transaction readiness level to satisfy the trigger threshold. In these embodiments, the sponsor can indicate an approval or consent to the automatic execution of the buyout transaction by the buyout processor 101 upon the trigger threshold being met, such as during the initial entry of the sponsor's benefit plan information into the system or via an option accessible to the sponsor via the sponsor interface 121. Similarly, the system can indicate to an insurer that, by providing a quote to a particular set of sponsor attributes, the insurer consents to the automatic execution of the buyout transaction according to that quote. This consent can be given by the insurer during a setup of an insurer's account with the system, via a setting accessible to the insurer via insurer interface 131, or as an approval that must be given when a insurer submits or updates a quote in insurer database 130.

In embodiments, the processing of the buyout transaction by the buyout processor 101 between the sponsor and the insurer at step 370 can include generating a buyout transaction recommendation and providing the buyout transaction recommendation to the sponsor for approval.

The buyout transaction recommendation includes information associated with the prospective buyout transaction. This can include information such as the benefit plan(s) associated with the transaction, the current state of the benefit plans, the members having the associated benefit plan(s), the quote, and information associated with the insurer.

The buyout transaction recommendation can also include information such as the transaction readiness level, the metrics that triggered the generation of the buyout transaction recommendation (i.e., how was the threshold reached/which threshold if one among several) and the sponsor's readiness metric.

The buyout transaction recommendation can also include a selectable option for the sponsor to accept or decline the proposed transaction indicated in the buyout transaction recommendation. Via the sponsor interface 121, the sponsor can provide a response to the buyout transaction recommendation indicating an acceptance or refusal of the proposed buyout transaction. In embodiments, the response can include sponsor-provided reasons for acceptance or refusal.

In embodiments, the buyout transaction recommendation can include the insurer information and quote that triggered the generation of the recommendation, as well as additional listings of insurers and quotes that were generated for the particular sponsor's situation. These additional listings can be ranked according to how close they were to triggering a recommendation to conduct the transaction recommendation (e.g. via a list of their respective transaction readiness levels and/or sub-component of the transaction readiness levels such as the readiness metric, correlation scores and/or quote similarity score), and can be limited to a particular amount of listings or to a particular range of transaction readiness levels (e.g., above a certain value, within a certain value of a trigger threshold, etc.). Thus, the sponsor can be presented with options of which insurers are “best suited” to handle the transaction given the sponsor's current situation and objectives. The sponsor can select one of the additional listings instead of the “winning” insurer quote to proceed with the transaction. In a further variation of these embodiments, the buyout processor 101 can receive a selection of more than one of the insurers and their quotes (which may or may not include the insurer quote that triggered the generation of the recommendation), and generate a multi-stage bidding process among the candidate insurers that allows a sponsor to obtain refined quotes from each participating insurer, and ultimately select the insurer and their corresponding quote following this process. The refining process can be a pre-set amount of “rounds” or can continue until the sponsor selects a winner, or until insurers drop out of the running such that no winner will be selected.

The buyout processor 101 can receive the response to the buyout transaction recommendation from the sponsor interface 121. If the response includes an indication from the sponsor to execute the transaction, the buyout processor 101 proceeds with executing the buyout transaction between the sponsor and the insurer, according to the terms of the recommendation. In embodiments, the response can include a selection of an insurer according to the terms presented.

In embodiments, the buyout processor 101 can, in response to a refusal from the sponsor, notify the insurer with or without a reason for refusal, can modify the readiness metric in response to the provided reason for refusal, or can simply do nothing.

In embodiments, the information associated with a sponsor in sponsor database 120 can include one or more sponsor checklists whose entries must be satisfied prior to proceeding with certain steps of the process as executed by the buyout processor 101. These checklists can be representative of processes or activities that must be performed by the sponsor and/or the insurer at particular points of the buyout preparation process in parallel to one or more of the processes executed by the buyout processor 101. These processes are sometimes, by their nature, required to be executed outside of the buyout processor 101 and thus their progress must be incorporated into the process via the checklists. Thus, at the appropriate points in the process, the buyout processor 101 verifies that any applicable checklist has been fully satisfied before proceeding with the next step in the process.

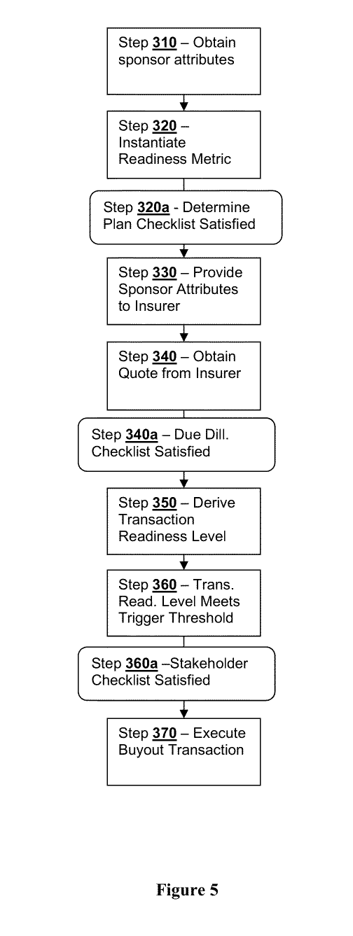

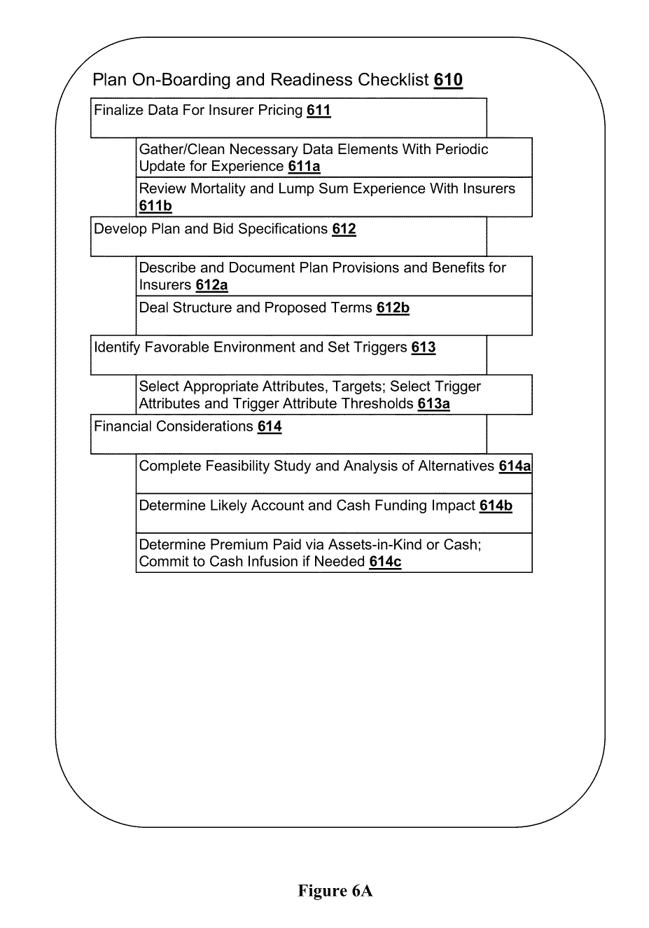

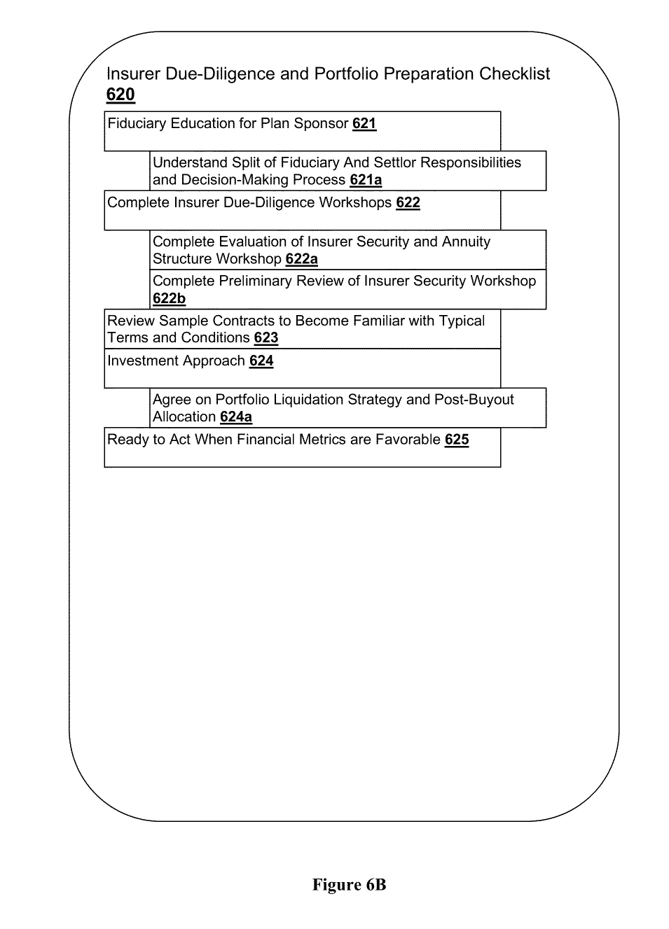

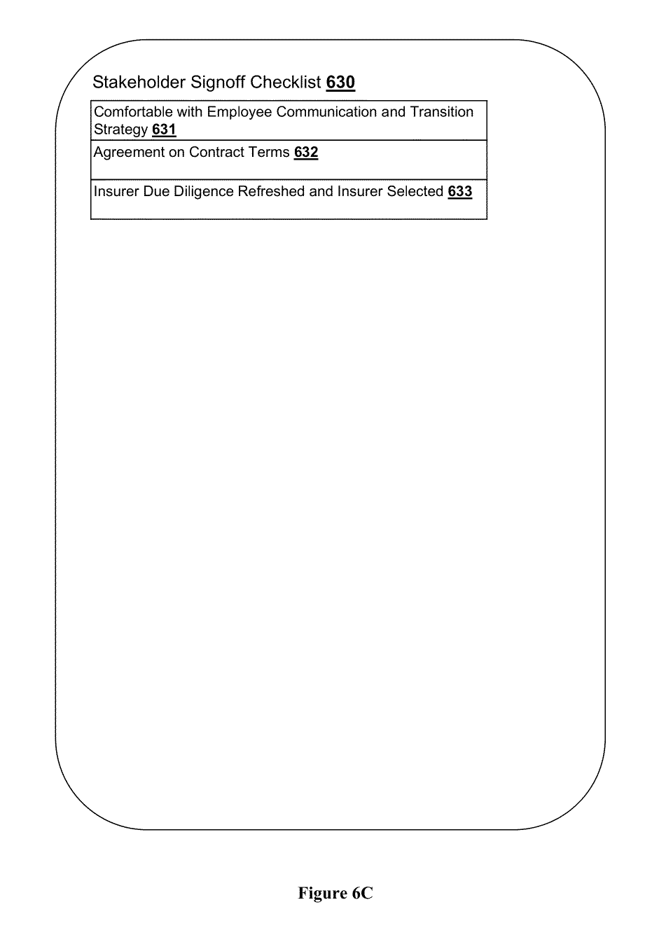

Contemplated sponsor checklists include a “Plan On-Boarding And Readiness Checklist” (“Plan Checklist”), an “Insurer Due Diligence and Portfolio Preparation Checklist” (“Due Diligence Checklist”) and a “Stakeholder Signoff Checklist” (“Stakeholder Checklist”), though others can be added to the process as necessary. Similarly, checklists can be removed as necessary to customize the process for a particular sponsor's circumstances. The checklists can be embodied as data objects having attributes representative of checklist entries whose values correspond to “satisfied” or “unsatisfied”, whereby all of the entries must be satisfied for the checklist to be satisfied. FIG. 5 is an illustrative example of the process flowchart of FIG. 3 incorporating the process steps associated with the plan checklist, the due diligence checklist and the stakeholder checklist. FIGS. 6A-6C provide illustrative examples of the plan checklist 610, the due diligence checklist 620, and the stakeholder checklist 630, respectively.

The plan checklist 610 is required for the generation of an insurer quote. As such, the buyout processor 101 reviews the plan checklist 610 and verifies that all of the entries of the plan checklist have been satisfied prior to providing the sponsor attributes to one or more insurers for the purposes of quote generation. Thus, in embodiments, the fulfillment of all of the entries of the plan checklist at step 320a of FIG. 5 serves as a trigger for the buyout processor 101 to provide the appropriate sponsor attributes to the one or more insurers to generate a quote at step 330. Contemplated entries in a plan checklist 610 include a “finalize data for insurer pricing” entry 611, a “develop plan and bid specifications” entry 612, an “identify favorable environment and set triggers” entry 613, and a “financial considerations” entry 614.

An entry in a checklist can have one or more sub-entries, such that all of the sub-entries of a particular entry must be satisfied for the entry to be satisfied. For example, as shown in FIG. 6A for the plan checklist 610, the “finalize data for insurer pricing” entry 611 can include a “gather and clean all necessary data elements with periodic update for experience” sub-entry 611a and “review mortality and lump-sum experience with insurers” sub-entry 611b; the “develop plan and bid specifications” entry 612 can include a “describe and document plan provisions and benefits for insurers” sub-entry 612a and a “deal structure and proposed terms” sub-entry 612b; the “identify favorable environment and set triggers” entry 613 can include a “select appropriate metrics and determine thresholds that drive execution” sub-entry 613a; and the “financial considerations” entry 614 can include a “complete feasibility study and analysis of alternatives” sub-entry 614a, a “determine likely accounting and cash funding impact” sub-entry 614b, and a “determine premium paid via assets-in-kind or cash, commit to cash infusion if needed” sub-entry 614c.

The due diligence checklist 620 is required for the plan to be “execution ready”, and as such the due diligence checklist must be satisfied before the buyout processor 101 proceeds to calculate the transaction readiness level at step 350. As shown in FIG. 6B, the due diligence checklist 620 includes a “fiduciary education for plan sponsor” entry 621, which includes a “understand split of settler responsibilities and decision-making process” sub-entry 621a, an “complete insurer due diligence workshops” entry 622 with “compete evaluation of insurer security and annuity structure workshop” 622a and “complete preliminary review of insurer security workshop” 622b sub-entries, a “review sample contracts to become familiar with typical terms and conditions” entry 623, an “investment approach” entry 624 with an “agree on portfolio liquidation strategy and post-buyout allocation” sub-entry 624a, and a “ready to act when financial metrics are favorable” entry 625.

The stakeholder checklist 630 is required for the buyout processor 101 to proceed with the processing of a buyout transaction between the sponsor and the insurer. The stakeholder checklist is representative of a final stakeholder “sign-off” on the buyout transaction before the transaction is finalized and executed. The stakeholder checklist can include a “comfortable with employee communication and transition strategy” entry 631, an “agreement on contract terms” entry 632 and an “insurer due diligence refreshed and insurer selected” entry 633.

In embodiments, one or more of the checklist entries can correspond to the selection or verification of metrics, preferences or values that are used in other parts of the process described herein. For example, the “describe and document plan provisions and benefits for insurers” of the plan checklist can be considered to be updated as “satisfied” by the buyout processor 101 upon the receipt of the sponsor attributes corresponding to the benefit plan, and any other sponsor attributes that are necessary for an insurer to provide a quote. In these embodiments, these types of checklist entries are updated automatically as part of the execution of the functions and processes of the buyout processor 101. Because various sponsor attributes, insurer attributes, their respective values and other values relevant to the processes described herein can be updated to account for updates and to maintain currency of the values, the checklist entries that are automatically updated can be updated such that, due to updated values caused by certain fluctuations (e.g., market data, updated quotes, etc.) can cause certain checklist entries (and/or sub-entries) to change from “satisfied” to “not satisfied” (or to “partially satisfied”) and thus prevent the checklist as a whole to be satisfied.

The checklists can be presented to the sponsor via interface 121, indicating which entries/sub-entries for each of the checklists have been satisfied, partially satisfied, and/or not satisfied such that the sponsor can update and provide information that satisfies checklist entries. Thus, the checklist entries (and/or sub-entries) that are not automatically updated by the buyout processor 101 can be satisfied by a manual update of the necessary data by the sponsor via interface 121 and/or by simply indicating a satisfaction of the entry via the interface 121 (for example, if employees have attended the requisite workshops, the sponsor personnel responsible for interacting with the system via interface 121 can indicate as such via a checkbox. In embodiments, where checklist items require certification or other documentation (such as according to the sponsor's company policy, due to legal requirements, etc.), the buyout processor 101 can be programmed to obtain the certification/documentation electronically from the appropriate source. In embodiments, the system can receive an electronic version of documentation submitted by the sponsor personnel via interface 121 (such as a scanned or electronic copy of the necessary documentation). In another example, the “ready to act when financial metrics are favorable” entry 625 serves as an acknowledgment or acceptance by the sponsor that the sponsor is willing to proceed with the remainder of the process, including through execution if the process proceeds accordingly. Thus, this entry is an acknowledgment that can be provided by the sponsor via interface 121.

It should be noted that, in certain situations, a checklist entry may be dependent on the execution of a prior function or process by the buyout processor 101 before it is possible for the entry to be satisfied. In these situations, the buyout processor 101 can be programmed to present the checklist entry only when it is possible for the checklist entry to be satisfied. In a variation, the buyout processor 101 can be programmed to present the entry as part of the checklist, but prevents the entry to be marked as “satisfied” by sponsor personnel until it is actually possible for the checklist entry to be satisfied in response to the prior required process being finished. For example, the stakeholder checklist 630 includes the “agreement on contract terms” entry 632. However, because the contract terms for a particular potential buyout transaction will include details such as the insurer's quote, the buyout processor 101 will not allow the sponsor personnel to mark the “agreement on contract terms” entry 632 as satisfied if a quote from an insurer has not yet been received at step 340 because prior to receipt it would have been impossible for the sponsor to have reviewed all of the terms without all of the terms being present.

In these embodiments, the buyout processor 101 can be programmed to present required or necessary data together with a particular checklist entry. Thus, if the sponsor personnel accesses a checklist, a checklist entry or checklist sub-entry to review, the sponsor can access the necessary data without having to obtain it elsewhere. Continuing with the illustrative example of the “agreement on contract terms” entry 632, the buyout processor 101 can present via the interface 121 all of the contract terms that have been received or derived by the system processes when the sponsor personnel accesses the specific entry.

In another example, the due diligence checklist 620 includes an entry 622 associated with completing certain workshops associated with the due-diligence process (the specific workshops represented by sub-entries 622a, 622b). Within entry 622 and/or sub-entries 622a and 622b, the system can provide the materials required for the workshops themselves to be accessed by the appropriate personnel that have to attend the workshops. These materials can include videos, presentations, documents, etc. hosted by the system or accessible via a link to a separate database (either the sponsor's own database or by a third-party provider of the workshops) and made accessible to the appropriate personnel. It may be desirable for the workshops to become available for attendance at certain points during the process. For example, certain workshops may be most beneficial (or be required) during the on-boarding process, whereas other workshops may flow from these initial workshops and thus be needed further along in the process. Alternatively, there may be certain workshops that are more appropriate to be attended during the on-going monitoring process after the on-boarding is completed (e.g., after the sponsor attributes have been set up and while the system monitors the conditions prior to a transaction readiness level meeting its thresholds). In these embodiments, the buyout processor 101 can be programmed (such as via a priori established trigger points entered or modified by the sponsor) to make the workshop materials available at the appropriate time. The buyout processor 101 can further be programmed to notify the attendees when the materials become available (e.g., such as via a generated email message).

The sponsor attributes stored in sponsor database 120 and/or insurer attributes stored in insurer database 130 can be updated regularly such that the information contained therein is current and up-to-date. For certain attributes, the updates can be performed periodically according to a schedule (e.g., daily, weekly, bi-weekly, monthly, semi-yearly, yearly, quarterly, etc.). For other attributes, the updates can be “pushed” to the sponsor database 120 or insurer database 130 from various sources of data, as soon as the data is updated at the source. Attributes can also be manually updated via corresponding interfaces. Thus, sponsor personnel can update attributes associated with the sponsor in the sponsor database 120 via the sponsor interface 121. Similarly, insurer personnel can update insurer attributes associated with the insurer within insurer database 130 via the insurer database 131.

When sponsor attributes in a sponsor database 120 are updated, the buyout processor can be programmed to automatically provide the updated attributes to insurers who have previously received those attributes. In embodiments, these can be insurers who have previously generated quotes (stored in insurer database 131) or are in the process of generating quotes based (at least in part) on the attributes that have been updated.

Additionally, when updated attributes are provided to the insurer, the buyout processor 101 can include instructions to the insurer to update any existing quotes to which the updated attributes apply within a certain time period (e.g., within a day, a week, etc.). The buyout processor 101 can monitor the time since the updated attributes have been provided and check that the quote has been updated in the appropriate time. In embodiments, if the insurer does not change the quote, the buyout processor 101 can assume that the updated attribute did not affect the quote, and can indicate that the quote is current as of the updated attributes.

In other embodiments, if the insurer does not change the quote, the buyout processor 101 can remove the quote from the insurer database 130 and provide a notification of the removal of the quote to the insurer via the insurer interface 131 or other channels (e.g., email, SMS messaging, MMS messaging, automated phone call to sponsor representative phone number, etc.). In a variation of these embodiments, the buyout processor 101 can, instead of removing the quote, simply flag the quote as “stale”, and remove the quote from use in any analysis or consideration. In these embodiments, the insurer can confirm via the insurer interface 131 that the quote is not changing within the allotted time. In response to such confirmation, the buyout processor 101 keeps the existing quote as the most “current” quote in the insurer database 130.

In embodiments, when attributes are updated, the buyout processor 101 can declare all quotes associated with updated attributes (generated from pre-updated attribute information) as outdated and therefore invalid. In other words, the quotes become void due to the updated attributes. In a variation of these embodiments, the quotes can be voided when attributes associated with the quotes are updated such that they change by a certain threshold amount either individually or collectively (i.e., minimal variances would not serve to void the quotes).

In embodiments, the quotes can have a duration influenced by or explicitly limited by the respective insurer. In addition to (or instead of) the other described techniques associated with assessing and/or updating the validity of a quote, the insurer can include limitations on the duration of the validity of the quote. For example, the insurer can add a limitation that a quote is only valid for a day, or that expires at the end of the day, etc. The buyout processor 101 can flag the quote as expired or delete the quote from the insurer database 130 after the quote duration passes the insurer-set limitations. In variations of these embodiments, the insurer-provided limitations on a quote can be subject to system rules, such that the insurer-provided limitations must be permissible or otherwise fall within the system-mandated rules for the quotes. For example, rules associated with the quotes can mandate that quotes be valid for a minimum duration. Thus, the buyout processor 101 will not accept insurer-provided limitations that cause the quote to expire prior to the minimum duration.

In embodiments, the sponsor database 120 can store historical sponsor attributes associated with sponsors. The historical sponsor attributes can be the historical values of current sponsor attributes, kept over time and as the sponsor attributes change. The historical sponsor attributes can also include attributes used in the past that are no longer used.

In embodiments, the sponsor database 120 can receive historical market information, which can include information associated with historical buyouts (e.g., details associated with the buyouts including the participants, plans, buyout prices, terms, etc.). Based on the historical market information, the buyout processor 101 can determine an optimal market condition for the sponsor and the sponsor's benefit plans. The optimal market condition can be based on statistical analysis associated with timing of the buyouts as well as the market conditions that may have influenced the buyouts. The optimal market condition can be used to adjust the readiness metric, such that the likelihood of the sponsor being ready for a buyout transaction can be moved closer to the present or forward into the future, thus taking advantage of “low” times that may be advantageous to the sponsor. In embodiments, the optimal market condition can be represented as a series of sponsor attributes with attribute values corresponding to the historical values of the attributes in the historical market information and historical buyouts. In these embodiments, the historical values of sponsor attributes can be imported by the sponsor database 120 and used as the target values for the sponsor attributes 221-22x used in determining the readiness level according to the readiness metric used in the analysis at step 320 and/or the transaction readiness level at step 350. Additionally, the buyout processor 101 can use information about particularly busy times of the year with regard to transactions to space out buyout transactions, reducing network and processing bottlenecks due to high-traffic demand.

As discussed above, the insurer database 130 can store historical quotes associated with one or more of the insurers using the system. The buyout processor 101 can use historical quotes applied to statistical models to analyze and identify trends over certain time periods for individual insurers, industry-wide quote behaviors, quote trends associated with certain kinds of buyouts and/or certain types of benefit plans, quote trends associated with the types of sponsors requesting them (e.g., sponsor industry, sponsor size, sponsor financial state, readiness level, etc.), quote trends associated with winning quotes and also non-winning quotes, and other trends determined from historical quote submissions. In embodiments, the historical quotes can be used to adjust a transaction readiness level by the buyout processor 101 by first calculating a statistical likelihood that a current insurer quote can go lower based on historical insurer quotes for a buyout share all of (or most of) the sponsor attributes 221-22x and other circumstances like time of year, inflation rate, and other external market conditions etc., and then applying the calculated likelihood as an adjustment factor to the transaction readiness level. For example, if statistical analysis (clustering quotes, averaging quotes for a set period of time and/or conditions, etc.) on a particular set of historical quotes for a particular month for a particular insurer bidding for a buyout on a particular plan shows that there is a high likelihood that the insurer will quote more favorably for the sponsor if asked again or pressed for a better quote (e.g., the average quote level for the collection of historical quotes for the set of sponsor attributes, plan, and other related set of conditions is more favorable for the sponsor), the buyout processor 101 can apply the calculated difference (e.g., as a percentage or decimal value representing the magnitude of difference between the current quote and the historical statistical average (in the case of using historical average values), or as a correlated score or adjustment factor mapped to a percentage difference on a pre-defined chart) to the transaction readiness level such that the transaction readiness level is lowered—to account for the fact that to get the sponsor to pull the trigger on the buyout transaction the quote must be improved and become more favorable. Conversely, if the quote is statistically unlikely to become more favorable because the statistical analysis of historical quotes illustrates this is as favorable as the insurer is likely to quote in these circumstances (e.g., the current quote has a favorable difference from a historical average or cluster), the buyout processor 101 applies the calculated difference, used as an adjustment factor to increase the transaction readiness level and thus bringing it closer to triggering the execution of the transaction.

In embodiments, if the statistical analysis on the current quote against historical quotes is sufficiently favorable (e.g., passing a pre-defined historical threshold that can be a certain percentage of difference between the current quote and historical average/cluster in the sponsor's favor), the buyout processor 101 can be programmed to proceed with the execution of the transaction at step 370 even if the trigger threshold has not been met (effectively skipping step 360). In a variation of these embodiments, the buyout processor 101 can be programmed to, upon determining that the current quote exceeds the historical threshold for historical quotes for that particular insurer, conduct the same analysis for the historical quotes of other insurers against the same historical threshold. In these embodiments, if the calculated difference remains for one or more of the historical quotes of other insurers remains above the historical threshold, the buyout processor 101 can be programmed to then proceed to the execution of the transaction at step 370. If the buyout processor 101 determines that the difference between current quote and the historical quotes of the other insurers does not exceed the historical threshold, the buyout processor 101 can adjust the transaction readiness level such that it is increased, and notify the sponsor that the historical threshold has been exceeded for the current insurer's historical quotes but not for other insurers, thus indicating that the market as a whole could be more favorable to the sponsor.

Some or all of the sponsor information 220 and insurer information 230 can be encrypted to maximize data security. When provided to an insurer for a quote, the sponsor information can be scrubbed such that the sponsor's identity cannot be determined from the provided sponsor attributes.

Once information is used for the generation of a quote and the buyout transaction processed, the associated data can be deleted from the various databases to conserve storage resources. As appropriate, data within the various databases described herein can be compressed, deleted or otherwise modified to conserve storage resources, conserve network bandwidth and/or reduce computational costs associated with executing the processes of the invention.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . . and N, the text should be interpreted as requiring only one element from the group, not A plus N, or B plus N, etc.

What is claimed is:

1. A pension management system comprising:
a sponsor database storing sponsor attributes associated with a sponsor;
a insurer database storing insurer attributes associated with a insurer;
a buyout processor programmed to:
instantiate a readiness metric for the sponsor based on the sponsor attributes according to a readiness ruleset;
receive a quote from the insurer, the quote generated based on at least some of the sponsor attributes;
derive a transaction readiness level as a function of the readiness metric, the quote and the insurer attributes; and
in response to the transaction readiness level meeting a trigger threshold, process a buyout transaction between the sponsor and the insurer.

2. The buyout management system of claim 1, wherein the sponsor attributes are regularly updated, and the quote is regularly updated in response to the regularly updated sponsor attributes.

3. The buyout management system of claim 2, wherein the quote is updated monthly.

4. The buyout management system of claim 2, wherein the quote is updated weekly.

5. The buyout management system of claim 2, wherein the quote is updated daily.

6. The buyout management system of claim 1, wherein the buyout processor programmed to process a buyout transaction between the sponsor and the insurer further comprises the buyout processor programmed to:
generate a buyout transaction recommendation, the buyout transaction recommendation including the quote;
provide the buyout transaction recommendation to the sponsor via a sponsor interface;
receive an indication to execute the buyout transaction from the sponsor;
in response to receiving the indication to execute, execute the buyout transaction between the sponsor and the insurer.

7. The buyout management system of claim 1 wherein the buyout processor programmed to process a buyout transaction between the sponsor and the insurer further comprises the buyout processor programmed to execute the buyout transaction.

8. The buyout management system of claim 1, wherein the sponsor attributes include at least one of an accounting cost of liabilities, a funding status, information associated with plan participants, and an implied yield.

9. The buyout management system of claim 1, wherein the insurer attributes include at least one of a insurer funding level, a insurer reputation, and insurer legal requirement compliance values.

10. The buyout management system of claim 1, wherein:
the sponsor database further stores historical sponsor attributes associated with the sponsor; and
the buyout processor is further programmed to predict an occurrence of an optimal readiness metric for the sponsor.

11. The buyout management system of claim 1, wherein the buyout processor is further programmed to:
receive historical market information including historical buyouts;
determine an optimal market condition based on the historical market information; and
adjust the readiness metric based on the determined optimal market condition.

12. The buyout management system of claim 1, wherein:
at least one sponsor attribute comprises a trigger attribute; and
the buyout processor is further programmed to, in response to at least one trigger attribute meeting a trigger threshold, process the buyout transaction between the sponsor and the insurer.
